(19) United States
(12) Patent Application Publication
(10) Pub. No.: US 2007/0022315 A1
(43) Pub. Date: Jan. 25, 2007

(54) DETECTING AND REPORTING CHANGES ON NETWORKED COMPUTERS

(75) Inventor: William M. Comegys II, Carson City, NV (US)

Correspondence Address: LAW OFFICES OF RONALD M ANDERSON, 600 108TH AVE, NE, SUITE 507, BELLEVUE, WA, 98004, US

(73) Assignee: University of Washington, Seattle, WA (US)

(21) Appl. No.: 11/425,912

(22) Filed: Jun. 22, 2006

Related U.S. Application Data
(60) Provisional application No. 60/695,171, filed on Jun. 29, 2005.

(51) Int. Cl. G06F 11/00

(52) U.S. Cl. 714/4

(57) ABSTRACT

A method and system detects changes to the computers on a computer network, and reports these changes in a simple and useful format. Two compatible components are used, including a Local Agent that runs locally on each computer, and a Digester that is run centrally by a system administrator. Changes in the system are detected and classified, and a report is produced that arranges data from several tables for different types of entities detected on the computers into a work order format for output to a text file. Any entities that are new and correspond to previously identified flagged exceptions are so identified, and any new unknown entities that were not previously found on a computer in the network are indicated so that they can be evaluated. Changes that may be undesirable can thus be readily identified for evaluation and possible removal before indicated by other third party sources.

### RELATED APPLICATIONS

This application is based on a prior copending provisional application, Ser. No. 60/695,171, filed on Jun. 29, 2005, the benefit of the filing date of which is hereby claimed under 35 U.S.C. § 119(e).

### BACKGROUND

The Internet has created tremendous improvement in the ease of accessing information about almost any topic and greatly facilitated the ease with which we can communicate via email, chat sessions, and other options. While much of the advantages of connection to the Internet is desirable, there are certain aspects of this free flow of information and interaction with others that can be less attractive. For example, connecting a computer to the Internet opens the computer to possible infection by viruses that can be conveyed via emails, or which can be unintentionally downloaded through a security hole in a browser or by other means. The effects of such undesirable code can range from the relatively innocuous, to the more destructive and damaging, for example, resulting in reformatting of a user's computer hard drive. Although it is difficult to understand the motivation that leads others to write malware such as viruses that are designed to spread rampantly over the Internet, the potential for harm to the innocent recipient of such attacks is unquestioned. Even viruses that do little direct damage can tie up processor resources and communication bandwidth by automatically spreading themselves over the Internet, for example, by automatically being conveyed to every person listed in the email address book of a computer user who has been infected.

While less damaging in their impact, another type of infection incurred as a result of connecting to the Internet is the adware or spyware that is automatically installed on an unsuspecting user's computer. The installation of such malware can occur simply as a result of connecting to a web site or downloading a file. A computer can become so overloaded with adware or spyware that its processor “bogs” down and becomes nearly unusable for running intended programs as a result of all of the computing resources used by undesired adware or spyware modules that are running in the background on the computer.

The problems related to malware—including viruses, and adware or spyware, become more of an issue for computers coupled to a network in a company. Although central management of such computers can reduce some of the labor intensive aspects of network security, it is still difficult to ensure that each computer on a network is secured against infection by viruses and other undesired malware modules. It is simply impractical for a system administrator to conduct full scans of each computer on a network on a regular basis. Limitations imposed on the types of files that can be downloaded and even specific web sites that can be reached can help to reduce the malware that reaches computers on a corporate network. Yet, users will often find ways to avoid such rules and manage to download viruses, adware and spyware, regardless of the best efforts of a system administrator.

Computer network security thus requires a more proactive approach than simply attempting to limit potential exposure of network computers to malware sites. Existing tools that are available for use on a network to detect viruses, adware, and spyware, employ pattern files to scan computers for known problems, constraining system administrators to react to new security problems only after a new problem has been identified and a patch has been made available by a third party. The patterns corresponding to known viruses, and adware or spyware are typically made available via centralized channels controlled by security-software vendors. However, outbreaks of new attacks will often run for several days before an appropriate pattern file can be generated and distributed to system administrators, along with a patch for removing or disabling the malware.

Another problem is the inefficiency with which conventional pattern files are used on a network. The most common approach is to scan each computer's hard drive during non-business hours in an attempt to detect any module in memory, or on the hard drive, or within the operating system registry, which might be a virus, adware or spyware. The computing time required to carry out such whole system scans is substantial. Even if done during the time a computer is not normally in use, such scans can interfere with other scheduled activity or may be a problem if a user simply want to work during the time that such a scan is scheduled to occur—even if outside normal business hours.

Accordingly, there is a need for a method and system that uses distributed collection points, treating all of the computers on a network collectively rather than individually, and capturing anomalies before patterns may have been published for them by a third party. Thus, there is a need for a proactive rather than a reactive security approach and a need to implement the proactive approach more efficiently than is possible with the tools currently available for such purposes. It should be possible to automatically and semi-automatically update the tables of known entities that represent security threats, flagged and unflagged, and to assemble the relevant data for all the computers on the network in formats that are manageable and that facilitate the process of system administration to avoid security problems spreading throughout a network. It would further be desirable to employ a centralized and consolidated manager for detecting anomalous modules on computers in a network, so that the nature of such modules can more efficiently be determined before a possible infection associated with the modules spreads widely within the network.

### SUMMARY

The following describes a method and system using a software implementation for detecting changes to the computers on a computer network, and for reporting these changes in a simple and useful format, so that any malware included in the changes can be efficiently identified. A current exemplary implementation is designed for use by a system administrator, but it could also be run as a service by a third party.

In contrast to more conventional methods, the novel method described herein detects changes to important features of all the computers on a network and manages and detects the changes centrally, rather than on each computer. These changes are detected and reported regularly. Working from a network computer, a system administrator can identify a new attack on the very first day that it first appears on and affects the network being administered. A new attack is listed with all the networked computers that the attack is currently affecting. This method enables the system administrator to update a central file of known problems, which will then be used to detect any subsequent occurrence of this attack on the networked computers.

For each computer on the network, the method detects and reports changes that could indicate security breaches related to malware modules being installed on the computers, or other modifications made that were not desired. These changes include, but are not limited to, changes in open network ports, changes to loaded code, and changes in startup modules. The method includes two compatible components: a Local Agent that runs locally on each computer, and a Digester that is run centrally by the system administrator.

More specifically, one aspect of this technology is directed to a method for centrally administering a network that includes a plurality of computing devices, to detect changes on the computing devices. The method includes the step of maintaining structured data for each of a plurality of different predefined types of entities. The structured data are updated from time-to-time, using data that are produced by a local agent running on each of the plurality of computing devices. The structured data are then used for detecting any new entities on any of the computing devices that are coupled to the network. New entities are identified as those that have recently been added to a computing device. The new entities are reclassified as flagged exceptions if they have previously been detected and have been determined to be undesirable. An undesirable entity might be associated with adware, spyware, viruses, bots, etc. In addition, the new entities are reported as being new unknown entities, if not previously detected on any of the computing devices that are being managed.

The method can further include the step of automatically creating a report indicating the computing devices on which new entities corresponding to flagged exceptions have been found. This report can then be employed to automatically initiate a work order to remove any new entity corresponding to a flagged exception from each computing device on which it was found.

Using the consolidated results represented by the structured data, a system administrator is readily enabled to reclassify new entities included in the structured data after manually evaluating their functionality. The manual evaluation might involve checking other sources for information that is useful in identifying the functionality of an entity, or may result in determining that an entity is innocuous and can be ignored, or determining that an entity was actually installed as part of a software or operating system update. However, an unknown entity may be found to be undesirable and thus classified with an exception flag, for removal from all of the computing devices on which it was found.

Another aspect of this approach is directed to a computing device readable memory medium on which machine instructions are stored for carrying out the steps of the method discussed above. Similarly, another aspect of the present approach is directed to a system that includes a memory in which machine instructions and data produced by each of the computing devices are stored, a network interface that enables communication over the network, and a processor coupled to the network interface and the memory. The processor executes the machine instructions stored in the memory to carry out a plurality of functions that are generally consistent with the steps of the method discussed above.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 illustrates an example of formatted output for a summary report of flagged exceptions in the current data for a network being administered with the present approach;

FIG. 2A illustrates an example of formatted output produced by the current approach, indicating a startup program that matched a flagged exception on a specific computer coupled to the network;

FIG. 2B illustrates an exemplary ticket that is automatically provided to deal with malware detected on a computer in the system;

FIG. 3 illustrates a flowchart of exemplary steps for implementing the Local Agent component;

FIG. 4 illustrates a flowchart of exemplary steps for implementing the Digester component, for handling each different type of entity (e.g., loaded code, network ports, startup programs);

FIG. 5 illustrates a flowchart of exemplary steps for evaluating and reclassifying an unknown exception identified on a networked computer;

FIG. 6 is a block diagram of an exemplary network on which the present approach might be used; and

FIG. 7 is a functional block diagram of an exemplary computing device that might be employed either for a central computing device for managing security on a network of computing devices, or for any of the computing devices on such a network.

### DESCRIPTION

Figures and Disclosed Embodiments Are Not Limiting

Exemplary embodiments are illustrated in referenced Figures of the drawings. It is intended that the embodiments and Figures disclosed herein are to be considered illustrative rather than restrictive.

Network and Computing Devices

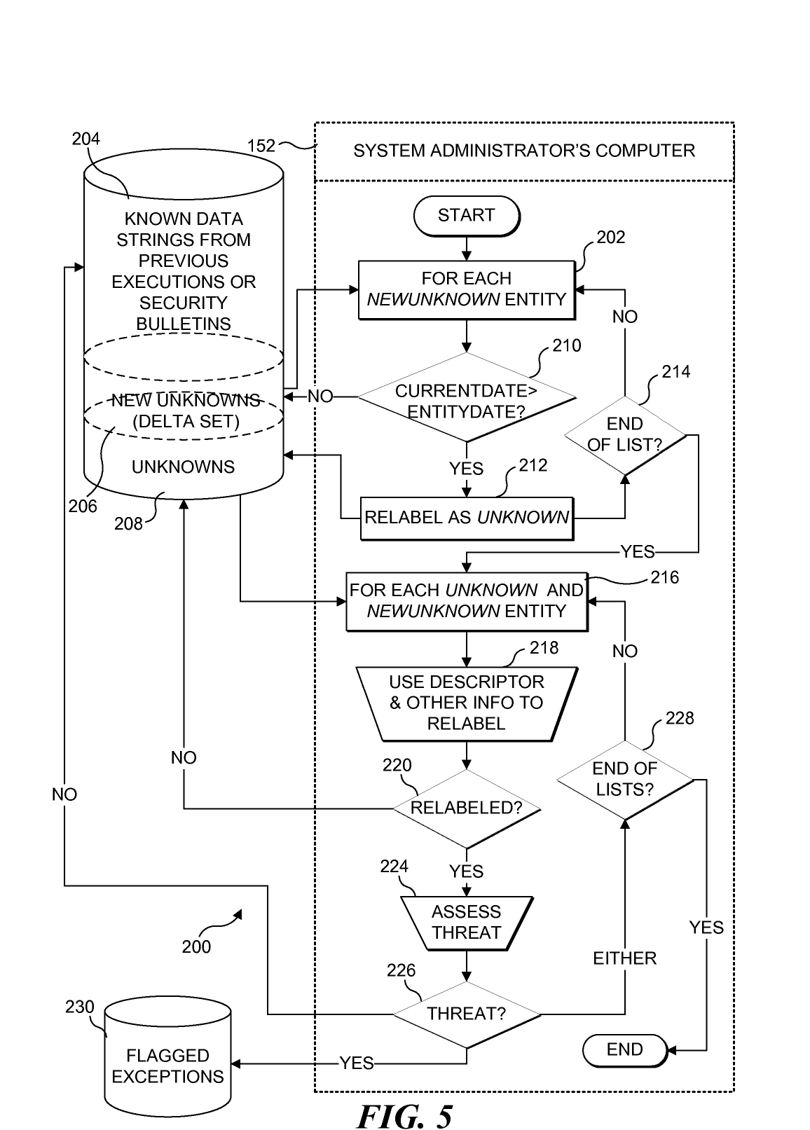

A schematic diagram 250 illustrates an exemplary network 252 in FIG. 6. The network includes one or more servers and network storage 254 and a plurality of client computing devices 256 (only two of which are shown in this simplistic diagram). The network might comprise hundreds or even thousands of such computing devices (or computers). At least one system administrator computing device 152 is included to carry out certain functions of the present approach, as discussed below. The servers, client computing devices, and administrator client computing devices are coupled in communication, e.g., using appropriate Ethernet and/or Internet protocols.

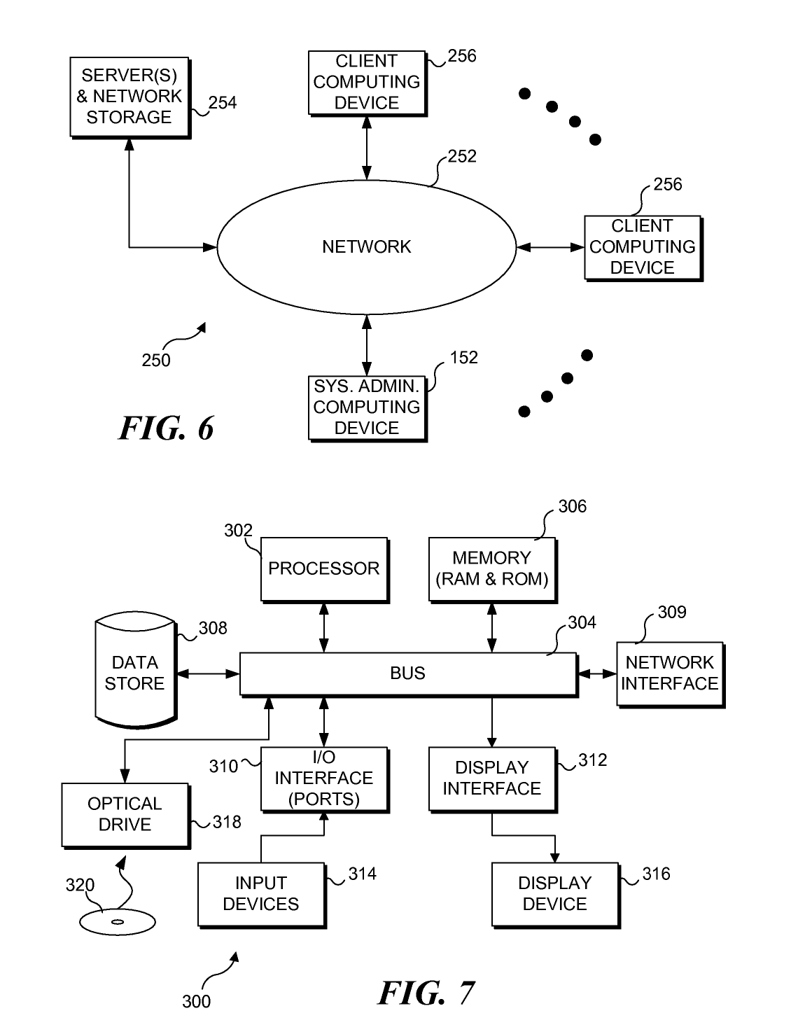

FIG. 7 illustrates details of a functional block diagram for a computing device 300, which is equally applicable to a server, a client computing device, and a system administrator computing device. The computing device can be a typical personal computer, but can take almost any other form in regard to the client computing device, for example, a personal data assistant (PDA), a cell phone, or an appliance. This list of computing devices is not intended to be limiting in any respect. A processor 302 is employed for executing machine instructions that are stored in a memory 306. The machine instructions may be transferred to memory 306 from a data store 308 over a generally conventional bus 304, or may be provided on some other form of memory media, such as a digital versatile disk (DVD), a compact disk read only memory (CD-ROM), or other non-volatile memory device. An example of such a memory medium is illustrated by a CD-ROM 320. Processor 302, memory 306, and data store 308, which may be one or more hard drive disks or other non-volatile memory, are all connected in communication with each other via bus 304. Also connected to the bus are a network interface 309, an input/output interface 310 (which may include one or more data ports such as a serial port, a universal serial bus (USB) port, a Firewire (IEEE 1394) port, a parallel port, a personal system/2 (PS/2) port, etc.), and a display interface or adaptor 312. Any one or more of a number of different input devices 314 such as a keyboard, mouse or other pointing device, trackball, touch screen input, etc. are connected to I/O interface 310. A monitor or other display device 316 is coupled to display interface 312, so that a user can view graphics and text produced by the computing system as a result of executing the machine instructions, both in regard to an operating system and any applications being executed by the computing system, enabling a user to interact with the system. An optical drive 318 is included for reading (and optionally writing to) CD-ROM 320, or some other form of optical memory medium.

The Local Agent

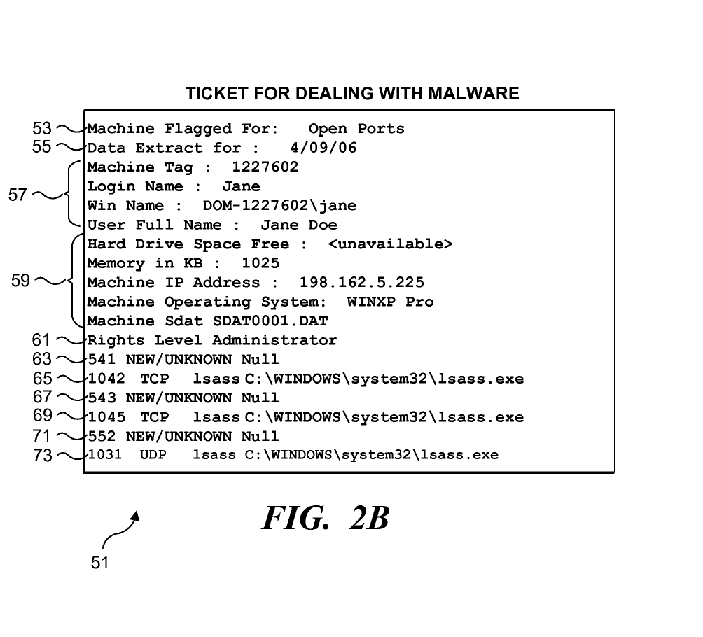

A small utility program or suite of simple programs reside on every computer on the network. This program (or suite of programs) is called the “Local Agent.” Details of the logic implemented in connection with the Local Agent are illustrated in an exemplary flowchart 100 in FIG. 3. If a computer enters or joins the network but does not have the Local Agent, a network server pushes the Local Agent onto this computer. If the computer refuses the Local Agent, its network connection may be terminated and access to the network refused until further authorization is provided by the system administrator. As shown for a single computer 102 in FIG. 3, the Local Agent runs when triggered by any of these events at a point 110. Triggering events include but are not limited to any of: a user responding to a prompt or a user login, as noted in a step 106, a network login, as noted in a step 104, a prompt from the system, such as a timer initiated prompt or a bootstrap prompt arising at a reboot, as indicated in a step 108. Another example of a system prompt is a system call to open a network port or to load a module.

Upon a triggering event occurring, the Local Agent gathers, collects, and formats data about entities on the computer, including (a) code loaded into memory that is running tasks, or loaded code, as noted in a step 112; (b) open network ports and the program associated with each open port, as noted in a step 120; (c) calls to run programs on computer initial program loader (IPL) or user login, all of which are collectively referred to as startup modules or program, as noted in a step 126; and, (d) inventory information, as noted in a step 132. The Local Agent transfers this information to a network location, with an identifier unique to this computer and timestamp, as indicated in steps 114, 122, 128, and 134. In a current implementation, for each of these different types of entities, the Local Agent writes the information to a file, assigns the unique identifier, and transfers this file to a predetermined network accessible location 116.

As an optimization, to minimize both its vulnerability and its runtime, the Local Agent does minimal processing. It captures the data of interest and transfers it to a network location for central processing. Thus, the Local Agent simply stores loaded code for the computer in a loaded code collection 118, port data in ports collection 124, startup programs for the computer in a startup programs collection 130, and inventory in an inventory collection 136. When triggered, the Local Agent on each of the other computers coupled to the network similarly runs and provides input to each of these different collections of data for those other computers.

The Digester

Although a home network might contain only two computers, larger commercial networks can contain hundreds or thousands of computers. The volume of status and diagnostic information available to a system administrator can thus understandably be overwhelming. Clearly, attempting manual scans of each computer in a network from a central system administrator computer is thus not practical if the network includes more than a few computers.

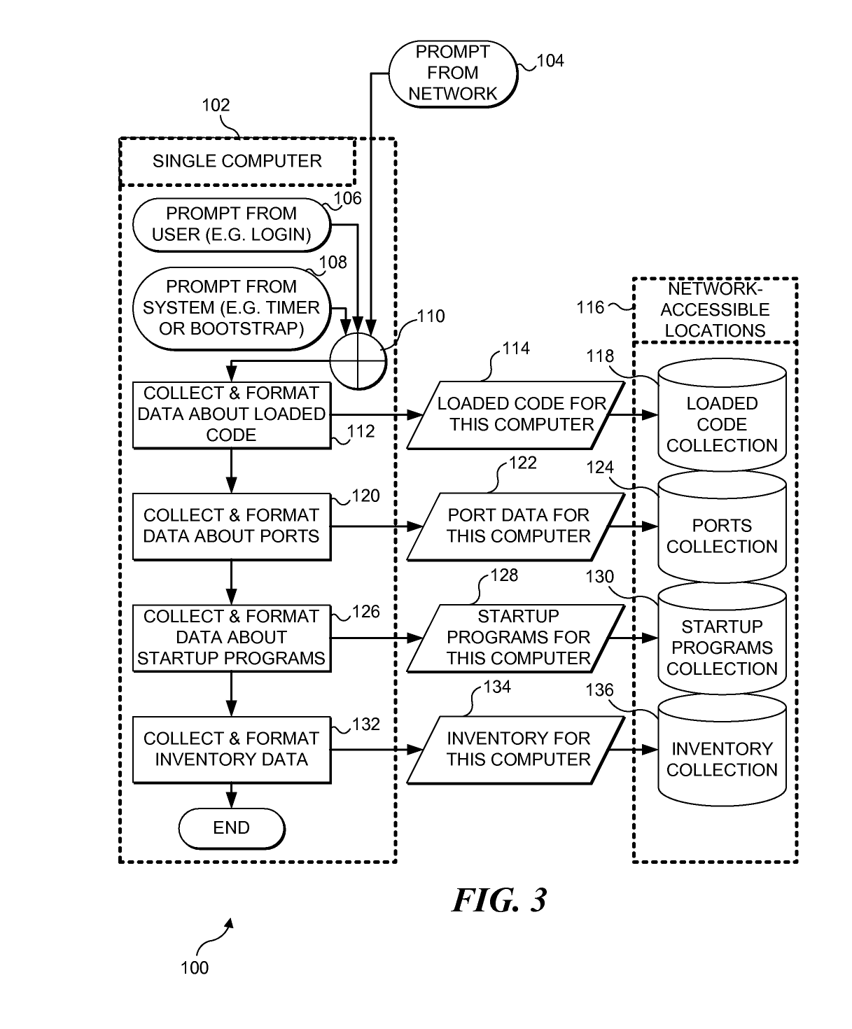

In the exemplary method for carrying out the present approach discussed above, each Local Agent running on each computer coupled to the network stores its information in a designated network location, e.g., in a specific directory on a network server. In an exemplary flowchart 150, FIG. 4 illustrates the logical steps implemented on a system administrator's computer 152. This system administrator computer runs a program (or suite of programs or software modules) referred to herein as the Digester, which processes the aggregate of all the data stored in network accessible locations 116 by the Local Agent running on each computer, to produce a concise and useful report for the system administrator. The output of the Digester is a useful visualization for identifying undesirable and unauthorized events on the network of managed computers.

It should be understood that the present approach can be applied in a very general sense to any type of network, including, for example, a local area network (LAN), a wide area network (WAN) that includes multiple and geographically disparate LANs, and a virtual network (VN). The network of computers being managed can be any collection of computers or other types of computing devices that have: (1) some mechanism for delivering the output of the Local Agent to the Digester; and, (2) a stable and useful identifier for the Digester. Also, the designated network accessible location might be accessed on the same LAN or on one or more different LANs that are part of the WAN. The designated network location might be different for different computers coupled to the network, or different for different types of entities being reported, and might also be accessed over the Internet or some other secure communication link. An intermediate-level agent might copy, move, or aggregate the data from the designated network locations, creating an image of that data at a different network location. In one exemplary embodiment, the system administrator uses a configuration file to establish and maintain the network locations, the file formats allowed, and other parameters of this system.

It will be understood that the term “system administrator” as used herein is not intended to limit the administrative aspects of this approach to only a person (and/or the computer operated by the person) that bears that title, but is generally intended to apply to any person (and/or the computer operated thereby) having responsibility for carrying out the functions described herein, to ensure the security of computers coupled to a network.

The Digester automatically reads the files from their storage location(s) on the network, which includes a current aggregation of the data 156 (by type of entity) that has been provided by the networked computers, as well as accessing inventory collection 136. In a step 154, the Digester identifies the unique item indicated for each computer in regard to network ports that are opened, loaded code, and startup programs; and, records this information in data structures comprising two arrays for each type of entity. The first array for one type of entity contains data strings 160 extracted by the Local Agent program. An example of a data string is:

| | | | |
|---|---|---|---|
| ltkrn70n | 7.00.0.003 | 349696 | LEAD Technologies, Inc. |

The above string represents a loaded module in memory. Starting from the left, the first field is the name of the module; the second field is the version number; the third field is the size in bytes; and the last field is the name of the originator of the code. The local agent does not process this information, except to organize and record the information for posting to the designated network location.

Indexed consistently with the first array, the second array of the data structure contains a list of all computers that reported this data string (i.e., an indication of the occurrences 162 of the data strings on the specific listed computers), indicating that each such computer included the same result, i.e., reported the same installed entity. The computers are listed in regard to their unique identifiers. An example of a record for the same data string that was reported for each of the indicated computers in the network in this second array follows:

| | | | | |
|---|---|---|---|---|
| 1146884 | 1146896 | 1146940 | 1182244 | 1182404 |
| 1182416 | 30010260 | 30010262 | 30010264 | 30064669 |
| 30064674 | | | | |

The preceding list of numbers are the unique identifiers for the computers that reported a data string equivalent to the “ltkm70n” loaded module string noted above. This list of computers is associated with the data string by sharing the same index across the two arrays.

As the Digester continues processing, it reads all the data strings stored in the network files produced by each Local Agent on each networked computer. For each data string, it checks to see whether that data record refers to loaded code, ports, or startup programs, which correspond to the three different types of entities of interest in this exemplary embodiment. The classification of reported entities identified by the Local Agent on the computers as ports, loaded code, or startup programs determines the pair of arrays that will be used in processing this data string, since a different pair of arrays is provided for each of these three different types of entities. If a data string is a unique item, meaning that it does not already correspond to an element in the first array for that type of entity, the Digester adds this data string to the first array, creates an entry for it in the second array, and adds the first computer to this new entry (i.e., record) in the second array to indicate that the data string was found on that specific networked computer. If the data string was not unique because it has already been found on another networked computer, then the Digester adds the computer unique identifier to the second array at the index for the record corresponding to this data string, so that the computer that was thus identified is added to other one or more computers for which the same data string record was already provided by one or more other Local Agents. This process continues until all of the files in the one or more specified directories on the network are processed by the Digester.

The paired-arrays described herein are one implementation of a three-dimensional (3-D) view (X,Y and X,Z) of the data underlying this problem. Using other data structures for this information would provide an equivalent solution; however, the paired-arrays employed in this exemplary implementation are an efficient and sufficient data structure.

Detection of Deltas and Their Classification

At this stage of processing, there are separate paired-arrays in memory for ports, loaded code, and startup programs and the corresponding computers on which each is loaded. The algorithm for comparing data is the same for loaded code, ports, or startup programs. For each of these types of entities, the program labels each entry or record according to whether it is:
a flagged exception (i.e., a known virus, malware, adware, spyware, bot, or other undesirable entity), as indicated in a step 164, wherein data identifying known flagged exceptions 166 is compared to the data string of the current entity; any matching data strings are added to the current flagged exceptions identified, in a step 168, and are used to create tables and service tickets in a step 170, automatically producing daily briefing summaries in a step 182; in one exemplary embodiment, one or more parameters for one or more flagged exceptions can be defined by the system administrator;
a new unknown entity (identified in a step 178); or
of no interest for present purposes, e.g., a benign, or innocuous, or an expected part of an intentionally installed program or program update; collections of unflagged data strings 176 of this type that have been seen on previous executions of the Digester are stored and any current unknown data strings are added to these collections.

Data strings other than those corresponding to previously known flagged exceptions are indicated in a step 172. These data strings may match unflagged (innocuous) data strings 176 that were seen on a previous execution of the Digester and therefore removed in a step 174, or may be new unknown data strings, as indicated in step 178. Since the new unknown data string entities don't match any known data string for any flagged exception or other previously identified unflagged data strings, they are added to a Delta set referenced in step 178.

The second classification (new unknown) is a central feature in the novelty of this approach. Not only are new unknown entries detected, they are listed explicitly for subsequent handling in regard to each computer where found, and their occurrence is fed back into the collection of previously seen, unflagged data strings. By detecting new unknown entities, this approach enables security breaches to be found before pattern files are available from a third party, and more importantly, before these new threats become widespread on this network of computers.

Currently, there is no provision in this novel approach for automatically identifying the nature of the unknown entries. Instead, because they are flagged as being new unknown entries, a system administrator or other person can readily manually carry out procedures that may identify the nature or functionality of these new unknown entities as quickly as possible. For example, a search of the Internet may be made for information that may be useful in identifying the nature of the entities. Further, if a given entity starts to spread to other computers on a network without any apparent intent of the users of those computers (or of the system administrator), steps can be taken to isolate and remove the entity from each affected computer to stop the spread immediately, since it will be likely that the entities are indeed some form of self-spreading, or other types of undesired malware.

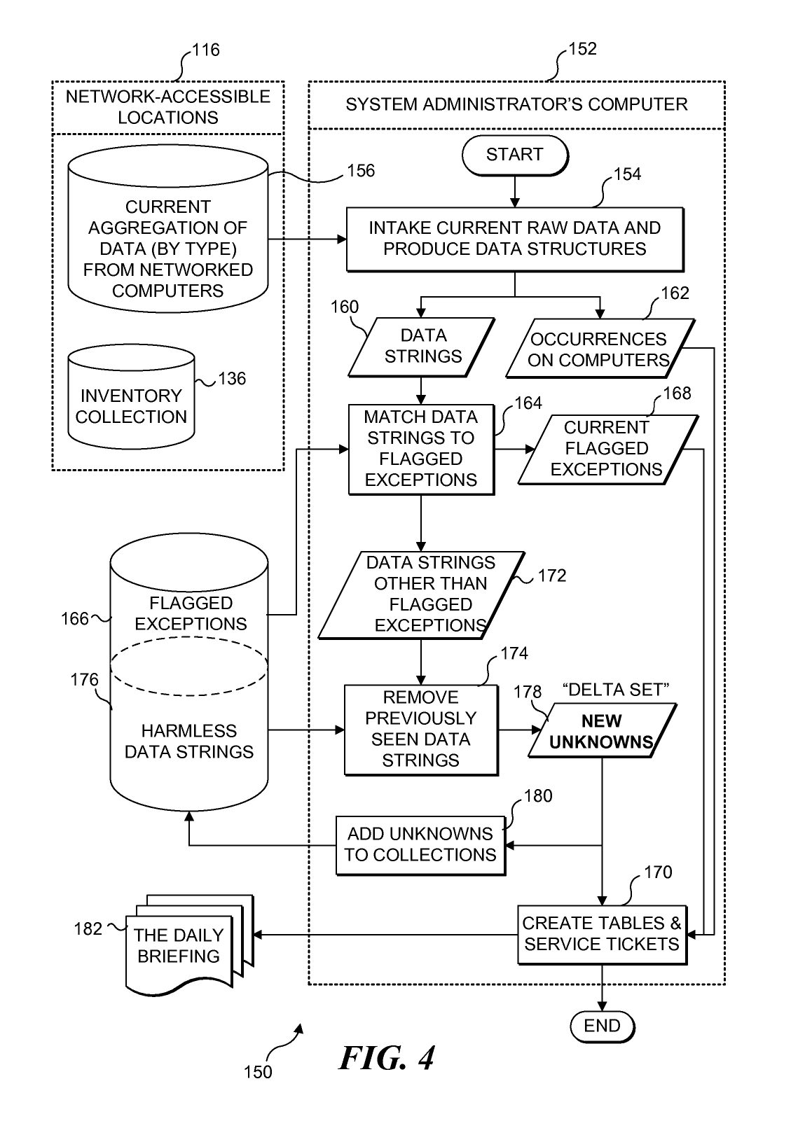

Details of the logic employed for evaluating and reclassifying unknown entities are illustrated in a flowchart 200 in FIG. 5. The process is applied to each NewUnknown entity, as indicated in a step 202. NewUnknown data strings 206 that were provided by the data reported by the computers on the network for each new unknown entity are thus evaluated manually, as described below. Also stored are data strings 204 that were seen on previous executions, and unknown data strings 208 (i.e., data strings that were previously seen and are still not evaluated). A decision step 210 determines if the “currentdate” is later than the “entitydate” on the data string currently being evaluated, i.e., determines if the data string was newly identified or has been previously identified in an earlier execution sequence by the Digester. If the data string was not just identified, a step 212 relabels or reclassifies it as “Unknown.” Otherwise, the data string classification is left as NewUnknown and the logic proceeds to a decision step 214, which determines whether the end of the list of NewUnknown data strings being evaluated has been reached. If not, the logic loops back to step 202. Following step 212, the logic also advances to decision step 214. If no further data strings remain in the list of NewUnknown data strings, the logic proceeds with a step 216.

A step 216 next indicates that the data strings for each Unknown and NewUnknown entity are next evaluated to determine the nature and/or functionality of the entity. A step 218 indicates that the person doing the evaluation may use the descriptor and other information that may be included with the data string or found from other sources to indicate the nature or functionality of the entity and thus, to relabel or reclassify the entity appropriately. A decision step 220 determines if it was not possible to relabel or reclassify the entity, and if not, it is returned to the collection of data labeled as Unknown. Otherwise, a step 224 provides that the threat to the security of computers on the network from this entity be assessed, e.g., by determining any possible adverse consequences of having the entity installed on any computers on the network. A decision step 226 determines if the entity currently being processed is a threat, and if so, it is added to the a collection 230 of flagged exceptions. If it is not a threat, the current entity is reclassified as a string seen previously and added to data strings 204. In either case, the logic then proceeds to a decision step 228, which determines if the last of the Unknown and the NewUnknown data strings have been evaluated. If not, the logic loops back to step 216, to enable evaluation of the next data string in either of those categories. Otherwise, the logic for this evaluation process is done.

The Digester program stores a cumulative table of these data strings for each different type of entity (e.g., loaded code, ports, and startup programs) in step 170 of FIG. 4. This step also provides for automatically creating work orders for investigating new unknowns and for removing flagged exceptions from the computers on which they were found.

For an initial execution, the cumulative tables of step 170 can be set up in a variety of ways. Examples of this initiation include: initializing a table as empty; downloading a table from a web-site that provides such tables; copying a table from a file on the network (e.g., a file produced by the system administrator); and manually editing an existing table. The cumulative tables are updated at the end of each execution of this approach and after obtaining the input from the Local Agents running on the computers coupled to the network, through the feedback from the detection of any new unknowns detected on the computers on the network. Since the tables include data from all of the previous times that the strings were provided by the computers coupled to the network, changes in the entities on each computer and on the network (i.e., the addition of new entities on each computer and thus, on the network) can readily be determined by this approach.

As noted above, the Digester program also stores collections for flagged exceptions 166 for each type of entity. These flagged exceptions include data strings corresponding to malicious, unauthorized, unwelcome, or vulnerable software modules that have already been identified. These collections are updated through a combination of input from commercial services, from other online resources for malicious patterns, and from manual editing and investigation by the system administrator or other personnel tasked with administering the secure operation of the network.

The program takes each paired-array (from one of loaded code, ports, and startup programs) and processes it, one record at a time. With the data structures described above (e.g., paired-arrays), each entry in these data records is unique. This entry is compared to the flagged exceptions. If there is a match between the entry currently being processed and an existing flagged exception, the entry is augmented with the corresponding description that was provided for the flagged exception, and the entry is set aside for reporting to the system administrator, since the corresponding entity should probably be removed from each computer on which it was detected, to avoid the undesired functionality that entity represents.

If an entry does not match any flagged exception, then it is compared to the cumulative table. If this entry does not match any existing entry in the cumulative table, it is labeled as a new unknown and set aside for reporting and will likely be the subject of an attempt to manually identify the nature and functionality of the entity represented by this entry. The data string for this entry is also recorded in the cumulative table with the label NewUnknown. If during the next execution of updating the data structure, this data string is still labeled as NewUnknown, the label is automatically changed to Unknown in a step 180 and the data string is then added to one of the collections of unflagged data strings 176 seen on previous executions by the Digester. As an alternative implementation, the administrator can set a time-window parameter, and the time stamp of each data string labeled NewUnknown will be compared to the current time; if the time stamp for the data string, plus the time-window parameter, is less than the current time. In this case, the label is then changed from NewUnknown to Unknown.

In a current exemplary implementation, the entries in the tables include the following fields:
an index for the current entry in the table;
number of machines on which this entry was found in this execution;
a classification label (e.g., ADWARE, WORM, UNKNOWN, NEW/UNKNOWN, OK (i.e., not a threat)).
a date on which this entry first occurred (FirstSeen);
a date on which this entry last occurred (LastSeen);
a description field, or a comment field; and
the data string.

An example of an entry in the table for a flagged exception is:

| | | |
|---|---|---|
| 3062 | 2 | SPYWARE 20050203 20050211 “minor threat |

interferes w/web

browser program” “sbcie028.dll 4, 1, 18, 380 208896 SideStep Inc.”

An example of an entry in the table for a new unknown entity is:

| | | | | |
|---|---|---|---|---|
| 3072 | 1 | NEW/UNKNOWN 20050601 | 20050601 | Null |
| “nssg | 1.30 | 573440 CANON INC.” | | |

Since this data string had not occurred on this network before, the Classification is set to NEW UNKNOWN, the FirstSeen and LastSeen dates are both set to the current date, and the comment string is set to Null. As noted above, the collection of all the new unknowns is called the Delta set, since that file shows the changes that have just been detected and which have not previously been detected on any of the computers in the network.

The method proceeds in a loop through the paired-arrays for each data type. This process continues until all of the data strings in the paired-array for this data type have been processed. The Delta set is then written to disk for storage.

In this exemplary implementation, the tables can be combined into one table in step 170, with labels identifying the flagged exceptions, the unknowns, the new unknowns, and known unflagged data strings. This table can be sorted by these labels, for efficiency in handling flagged exceptions and in handling unknowns and new unknowns. The table indicating new unknowns clearly facilitates manually determining the nature and functionality of new unknown entities.

The exemplary method described above takes in the voluminous data regarding entities on each computer that is provided by the computers on a computer network. It separates that large volume of data into lists of those entities of no concern to a system administrator, those entities that are flagged exceptions, and new entities that have shown up on the machines in the data set since the last time that the program was run to update the data structure maintained by the Digester. The purpose is not to detect a change on a single computer, but to detect changes in loaded code, ports, or startup programs on all of the computers on a computer network and report such changes in a format that facilitates action by a system administrator or by other personnel tasked with responding to potential security threats to the network and computers connected thereto. By creating a Delta set, this method is able to find compromises before the commercial computer security firms have identified this threat and made pattern files available on their disseminated data, for subsequent detection by subscribers.

During execution, a NewUnknown data string of any type (e.g., loaded code, ports, startup programs) will be listed in the Delta set. The NewUnknown data string will also be added to the cumulative table of previously seen data strings; and, it will be reported. In the report, the occurrences of this NewUnknown will be summarized, and each NewUnknown entry will automatically generate a work order for manually investigating the nature of the unknown entity. This method will also automatically promote a NewUnknown to an Unknown by comparing the recorded date of the corresponding data already in the structured data files with the current date for this entity. (Further details of this process are discussed below in connection with FIG. 5.) If information from the report, from the work order, from actions taken in response to the work order, or from third party sources helps to identify this entity, then the NewUnknown or Unknown label can be semi-automatically overwritten to reclassify the entity in an appropriate different category. If the identifying information indicates that this entity is a threat, then its entry is moved to the table of flagged exceptions. Otherwise, the entry remains in the table of previously seen entities, but is no longer unknown.

As an example of the relabeling in steps 216 and 218, the system administrator may add additional flags to customize the approach used for the management of the computers on a particular network. For example, a screen saver could appear in The Daily Briefing report as a library (.dll) and an executable file (.exe) that are listed as loaded modules:

NEW/UNKNOWN 20060203 20060203 cool_screensaver Coolss.dll

6.0.5.1 90165 ScreenCo

NEW/UNKNOWN 20060203 20060203 cool_screensaver Coolscreen.exe

| | |
|---|---|
| 6.0.4.1 | 90112 ScreenCo |

To the data string information described above, the flag “NEW/UNKNOWN” and two dates have been prepended. The dates indicate the date of first occurrence and the date of most recent occurrence; since this entity is new, these dates coincide in this example, to Feb. 3, 2006.

The installation may also have included a registry entry to run on startup, which is listed in The Daily Report, as shown in the following example:

NEW/UNKNOWN 20060203 20060203 cool_screensaver

HKCU\SOFTWARE\Microsoft\Windows\CurrentVersion\Run\
“Cool Screen Saver” = “C:\Program Files\Coolss\coolscreen.exe”
(REG_SZ)

If the screen saver opens port 3451 to download images, The Daily Briefing will record this action as:
NEW/UNKNOWN 20060203 20060203 cool_screensaver 3451 UDP coolscreen C:/Program Files/Coolss/coolscreen.exe

The system administrator may find this screen saver code undesirable, although it is a popular download among computer users. To manage the appearance of this application on his computer network, the system administrator can create a new flag in the configuration file:
Flag: COOLSS

The system administrator would also replace the “NEW/UNKNOWN” on all four of the strings in this example, with the new flag “COOLSS.” On all subsequent runs of the Digester, every aspect (library, executable, startup registry entry, port) of the screen saver will be reported as undesirable code, with the flag “COOLSS”.

Reporting the Results

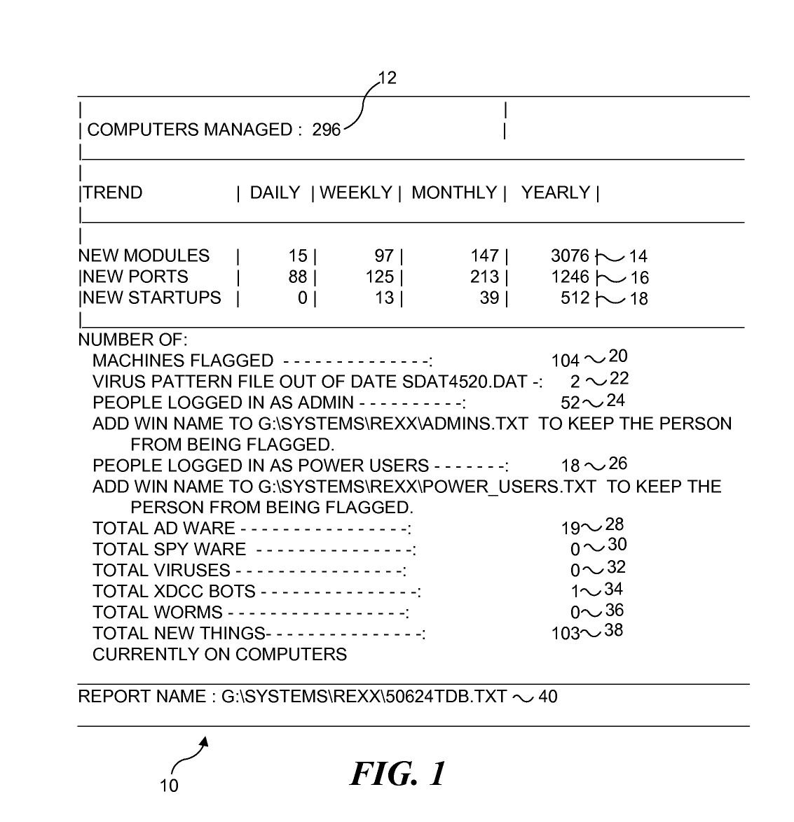

The utility of this invention is enhanced by its reporting methods. The data are brought together from several tables, arranged into a work order format, and output to a text file. An example of the summary cover page 10 of such a report is illustrated in FIG. 1. A first line 12 of this cover page indicates that the security of 296 computers are being managed on the network. Lines 14, 16, and 18 respectively indicate the numbers of new modules, new ports, and new startup programs that were detected on these computers at different times, including daily, weekly, monthly, and yearly. A line 20 indicates the number of machines (i.e., computers) that were flagged during the last update as having new entities; a line 22 indicates the number of computers having virus pattern files out of date; and a line 24 indicates the number of people who had logged into their computer as an administrator (rather than as just a “user”), while a line 26 indicates the number who logged in as a power user. There is also an option to add the persons logged in as administrator or power user to a list of users to prevent them from being flagged for this log in the future. Lines 28, 30, 32, 34, 36, and 38 respectively indicate the total numbers of adware, spyware, viruses, XDCC bots, worms, and total new entities that were last reported by the computers on the network. A line 40 lists the address and name of the report.

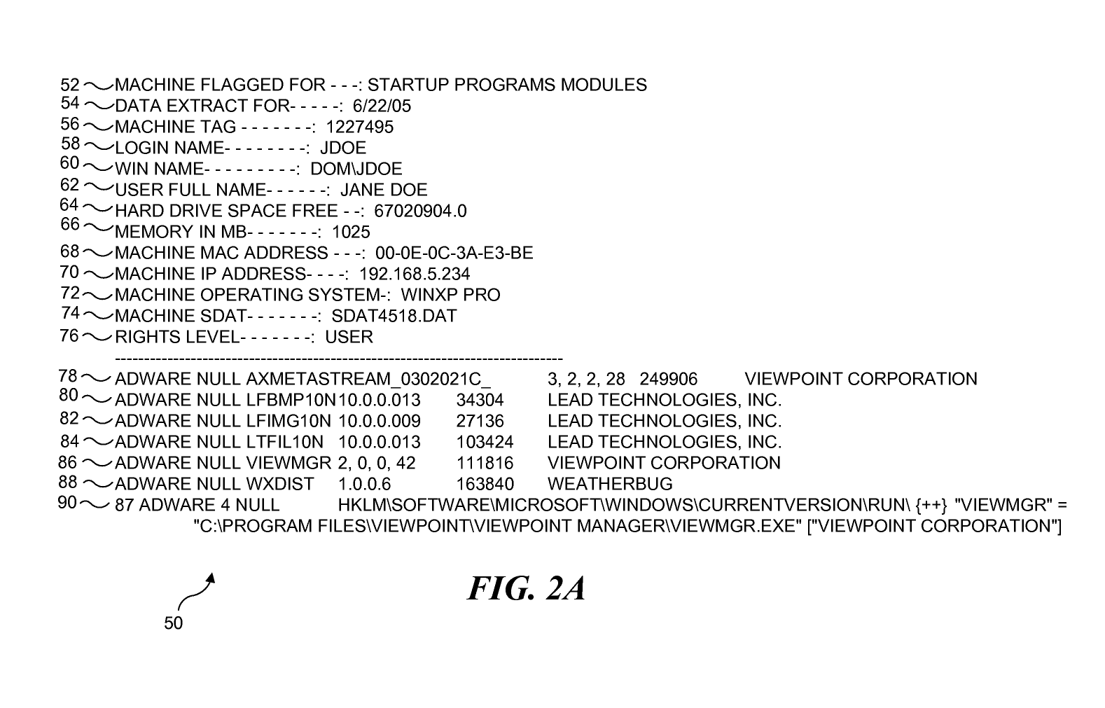

An example of a work order 50 is presented in FIG. 2A, while FIG. 2B illustrates an exemplary ticket 51 that is automatically produced by the present approach to deal with a malware software module that was found on one of the computers of the network. These documents in FIGS. 1, 2A, and 2B are generated automatically by combining: (a) the current flagged exceptions; (b) the current NewUnknowns; and, (c) the inventory data. The inventory data enable the flagged entities and the new unknown entities to be correlated with, for example: specific hardware, users, equipment configurations, and network addresses. These output data are formatted for human readability, but in this exemplary embodiment, are also preferably delineated in a manner compatible with post-processing, for use in databases, spreadsheets, word-processors, and in connection with other software.

Specifically in regard to exemplary work order 50 in FIG. 2A, a line 52 indicates that this example is for startup program modules, while a line 54 indicates the date that the data were extracted by the local agent, for a machine tag indicated on a line 56. Lines 58, 60, and 62 respectively indicate a login name for the user, a WINDOWS™ name (i.e., domain and network name), and the user's full name. Lines 64, 66, 68, 70, and 72 provide information about this computer, including, respectively, the hard drive free space, the memory size (RAM) in megabytes, the computer MAC address, the computer IP address, and the operating system running on the computer. A line 74 indicates the name of the data file listing the entities found on this computer, and a line 76 indicates the rights level of the user running this computer. Lines 78, 80, 82, 84, 86, and 88 list the various related adware startup program modules on which this work order is focused. A line 90 indicates a registry entry for the adware, which will preferably be removed.

Exemplary ticket 51, which is illustrated in FIG. 2B, is produced so that a technician can deal with an apparent malware software module found on one of the computers of the network, as discussed above. A line 53 on the ticket indicates that this computer or machine has been tagged because the malware software module opens ports on the network. A line 55 indicates the date that the data for this malware module was extracted. Lines 57 identify the machine and the user who operates the computer, and lines 59 provide information about the hard drive and memory resources on the computer and other pertinent information. A line 61 indicates that the user is logging onto the computer with administrative rights. Lines 63, 67, and 71 all indicate that the software module is no longer in the new or unknown status, since it has been identified. Lines 65 and 67 indicate the TCP ports that have been opened by the software module, i.e., lsass.exe in this example. Similarly, line 73 indicates a UDP port that has been opened by the same software module. Clearly, modules that open network ports without the authorization of the user represent potential risks to the computers on which the modules are installed. Accordingly, in this case, the technician will address this problem by removing the malware software module, lsass.exe, from the computer hard drive. In this example, this software module was actually identified as malware that should be removed using the present approach, about two days before it was identified as such by third party providers of such services. Thus, the malware was detected and removed from any computer infected by it on the network well before it would have been using more conventional approaches.

Contemplated extensions of the present approach include using distributed computing for the Digester (i.e., running the Digester program on multiple computers) to achieve increased efficiency. If, for example, the number of computers is sufficiently great, the Digester component could be run hierarchically by a business department or by a computer sub-network, rather than by the full system administrator computer. This approach would facilitate a more distributed (e.g., by department) management, rather than the single central management approach discussed above and would thus be very beneficial for certain business requirements. In addition, such a hierarchical approach would facilitate the management of a network having too many computers to be efficiently accommodated, even by the approach described above.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

The invention in which an exclusive right is claimed is defined by the following:

1. A method for centrally administering a network that includes a plurality of computing devices, to detect changes on the computing devices, comprising the steps of:
(a) maintaining structured data for each of a plurality of different predefined types of entities, the structured data being updated from time-to-time, using data that are produced by a local agent running on each of the plurality of computing devices;
(b) using the structured data for detecting any new entities on any of the computing devices that are coupled to the network, where the new entities are entities that have recently been added to the computing devices since the structured data were last updated; and
(c) reporting the new entities as new unknown entities if not previously detected on any of the computing devices that are coupled to the network.

2. The method of claim 1, further comprising the step of reclassifying the new entities as flagged exceptions if previously detected and determined to be undesirable.

3. The method of claim 2, further comprising the step of automatically creating a report indicating the computing devices on which new entities corresponding to flagged exceptions have been found.

4. The method of claim 3, further comprising the step of employing the report to automatically initiate a work order to remove the new entity corresponding to a flagged exception from any computing device on which it was found.

5. The method of claim 1, further comprising the step of enabling a user to reclassify new entities included in the structured data after manually evaluating the functionality of the new entities.

6. The method of claim 2, further comprising the step of enabling a system administrator to define at least one parameter used to identify at least one flagged exception.

7. A computing device readable memory medium on which machine instructions are stored for carrying out the steps of claim 1.

8. A method for detecting and reporting changes on a plurality of computing devices connected to a network, comprising the steps of:
(a) for each of the plurality of computing devices that is connected to the network, from time-to-time automatically:
(i) detecting any of a plurality of different predefined types of entities on the computing device; and
(ii) storing data identifying the different types of entities detected on the computing device, at a designated location accessible over the network, in association with an identification of the computing device; and
(b) at a central computing device, automatically periodically:
(i) updating and storing a data aggregation for each different predefined type of entity, wherein the data aggregation includes the data stored by the computing devices for that predefined type of entity; and
(ii) comparing the data aggregation for each different predefined type of entity to data for entities of that predefined type that have been previously detected on any computing device connected to the network, to identify any new unknown entities that have not been previously detected on any computing device connected to the network, and reporting to a user each computing device on which any new unknown entity was detected.

9. The method of claim 8, further comprising the step of comparing the data aggregation for each different predefined type of entity to flagged exceptions for that predefined type of entity, to determine if any of the entities detected on the plurality of computing devices corresponds to a flagged exception that was previously identified as undesirable, and reporting to a user each computing device on which an entity is found that matches a flagged exception.

10. The method of claim 8, further comprising the step of adding each new unknown entity that was detected to a group of previously identified unknown entities of that predefined type.

11. The method of claim 8, further comprising the step of enabling a user to evaluate any new unknown entity reported, to attempt to determine whether the new unknown entity should be reclassified as a flagged exception that is undesirable and should be removed from each computing device connected to the network on which said new unknown entity was detected.

12. The method of claim 8, wherein after the new unknown entity is reported to the user, further comprising the step of reclassifying any new unknown entity as an unknown entity, until a functionality of the unknown entity is determined.

13. The method of claim 12, further comprising the step of reclassifying an unknown entity that has been evaluated and found not to be undesirable, as a known entity that is not a flagged exception.

14. The method of claim 8, wherein for the computing devices on which an entity corresponding to a flagged exception was found, further comprising the step of automatically preparing a work order to facilitate removal of the entity from each computing device on which the entity was found.

15. The method of claim 8, wherein the plurality of different predefined entities comprise at least two of:
(a) loaded executable code;
(b) ports that are open; and
(c) startup programs that are executed when an operating system on the computing device is restarted.

16. The method of claim 8, wherein the step of storing the data aggregation comprises the step of combining the data stored by the computing devices in a data structure, for each predefined type of entity.

17. The method of claim 8, further comprising the step of enabling a user to determine whether an unknown entity that has been reported is undesirable for the computing devices connected to the network.

18. The method of claim 17, wherein if an unknown entity has been reported as undesirable, further comprising the step of changing a flag for said entity indicating that it is an unknown entity to an existing flag indicating that it is an undesirable type of entity, or to a new flag for the data aggregation indicating that it is an undesirable type of entity.

19. The method of claim 8, wherein the flagged exceptions are each associated with at least one of:
(a) adware;
(b) spyware;
(c) executable code that can threaten normal operation of at least one computing device that is coupled to the network;
(d) bots that perform undesired functions; and
(e) worms that perform undesired functions.

20. The method of claim 8, further comprising the steps of:
(a) collecting and formatting inventory data for each of the computing devices coupled to the network, the inventory data indicating specific application programs and hardware that are installed on the computer; and
(b) storing the inventory data at an accessible location on the network.

21. The method of claim 20, further comprising the step of enabling a user to access the inventory data to assist in evaluating any unknown entity that is reported in the data aggregation.

22. The method of claim 8, further comprising the step of pushing a local agent onto any computing device that attempts to connect to the network that is not already executing the local agent, wherein the local agent implements steps 8(a)(i) and 8(a)(ii).

23. The method of claim 8, wherein the step of detecting any of a plurality of different predefined types of entities on the computing device is carried out in response to at least one of:
(a) a user logging in on the computing device;
(b) a user logging in on the network;
(c) rebooting the computing device;
(d) in response to a user prompt;
(e) a request being received over the network;
(f) lapse of a predefined time interval; and
(g) a system call to open a network port or to load a module.

24. A computing device readable memory medium on which machine instructions are stored for carrying out the steps of claim 8.

25. A system for centrally administering a plurality of computing devices that are coupled to a network, to detect changes on the computing devices, comprising:
(a) a memory storing machine instructions and data produced by each of the computing devices;
(b) a network interface that enables communication with over the network; and
(c) a processor coupled to the network interface and the memory, the processor executing the machine instructions to carry out a plurality of functions, including:
(i) creating and maintaining structured data for each of a plurality of different predefined types of entities, the structured data being updated from time-to-time, using data that are produced by a local agent on each of the plurality of computing devices;
(ii) using the structured data for detecting any new entities on any of the computing devices that are coupled to the network, where the new entities are entities that have recently been added to the computing devices since the structured data were last updated; and
(iii) reporting the new entities as new unknown entities if not previously detected on any of the computing devices that are coupled to the network.

26. The system of claim 25, wherein execution of the machine instructions further causes the processor to reclassify the new entities as flagged exceptions if previously detected and determined to be undesirable.

27. The system of claim 25, wherein execution of the machine instructions further causes the processor to automatically create a report indicating the computing devices on which new entities corresponding to flagged exceptions have been found.

28. The system of claim 27, wherein execution of the machine instructions further causes the processor to employ the report to automatically produce a work order to remove the new entity corresponding to a flagged exception from any computing device on which it was found.

29. The system of claim 25, wherein execution of the machine instructions further causes the processor to enable a user to reclassify new entities included in the structured data after manually evaluating their functionality.
